(19) United States
(12) Patent Application Publication
(10) Pub. No.: US 2015/0334357 A1
(43) Pub. Date: Nov. 19, 2015

(54) WAFER LEVEL CAMERA HAVING MOVABLE COLOR FILTER GROUPING

(71) Applicant: OMNIVISION TECHNOLOGIES, INC., Santa Clara, CA (US)

(72) Inventors: Chia-Ching Wang, Hsinchu City (TW); Jau-Jan Deng, Taipei (TW); Yun-Chiang Hsu, Yangmei City (TW)

(73) Assignee: OMNIVISION TECHNOLOGIES, INC., Santa Clara, CA (US)

(21) Appl. No.: 14/279,744

(22) Filed: May 16, 2014

(51) Int. Cl. H04N 9/04; H04N 5/225; H04N 5/369

(52) U.S. Cl. CPC H04N 9/045; H04N 5/369; H04N 5/2254

(57) ABSTRACT

An image capture unit includes an image sensor and a lens structure disposed proximate to the image sensor to focus an image onto the image sensor. A movable color filter grouping is disposed over the lens structure. The movable color filter grouping includes a plurality of N color filters arranged therein such that all light that is incident upon the image sensor through the lens structure is directed through only one of the plurality of N color filters of the movable color filter grouping per each exposure of the image sensor. A positioning device is attached to the movable color filter grouping to reposition the movable color filter grouping such that substantially all of the light that is incident upon the image sensor through the lens structure is directed through a different one of the plurality of N color filters for each successive exposure of the image sensor.

### BACKGROUND INFORMATION

1. Field of the Disclosure

The present invention relates generally to image sensors, and more specifically, to a color wafer level camera with a movable color filter grouping.

2. Background

An image capture unit typically includes an image sensor and an imaging lens. The imaging lens focuses light onto the image sensor to form an image, and the image sensor converts the light into electric signals. The electric signals are output from the image capture unit to other units in a host electronic system or a subsystem. The electronic system may be a mobile phone, a computer, a digital camera or a medical device.

As the use of image capture units in electronic systems increases, so do the demands for image capture unit features, capabilities and device dimensions. For example, image capture units are increasingly required to have lower profiles so that overall sizes of electronic systems including the image capture units can be reduced while at the same time not sacrifice quality in the optical images that are captured. The profile of an image capture unit may be associated with the distance from the bottom of image sensor to the top of the imaging lens.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is a schematic diagram of an image capture unit including an imaging lens and an image sensor.

FIG. 1B is a schematic diagram of a low profile image capture unit including a low profile imaging lens and an image sensor.

FIG. 1C illustrates an image sensor having four partitioned areas with four low profile imaging lenses.

FIG. 2A shows one example of a low profile image capture unit that includes movable color filter grouping disposed over a single lens structure disposed proximate to an image sensor having a single partition in accordance with the teachings of the present invention.

FIG. 2B shows an example of pixel cell image data values in the pixel array of image sensor after an exposure of image sensor with all of the incident light directed through a first color filter of a movable color filter grouping and lens structure in accordance with the teachings of the present invention.

FIG. 2C shows an example of pixel cell image data values in the pixel array of image sensor after an exposure of image sensor with all of the incident light directed through a second color filter of a movable color filter grouping and lens structure in accordance with the teachings of the present invention.

FIG. 2D shows an example of pixel cell image data values in the pixel array of image sensor after an exposure of image sensor with all of the incident light directed through a third color filter of a movable color filter grouping and lens structure in accordance with the teachings of the present invention.

FIG. 2E shows an example of pixel cell image data values in the pixel array of image sensor after an exposure of image sensor with all of the incident light directed through a fourth color filter of a movable color filter grouping and lens structure in accordance with the teachings of the present invention.

FIG. 2F shows an example of pixel cell image data values in the pixel array of image sensor after an exposure of image sensor with all of the incident light directed through a fourth color filter of a movable color filter grouping and lens structure in accordance with the teachings of the present invention.

FIG. 3 shows another example of a low profile image capture unit that includes movable color filter grouping disposed over a single lens structure disposed proximate to an image sensor having a single partition in accordance with the teachings of the present invention.

FIG. 4 shows yet another example of a low profile image capture unit that includes movable color filter grouping disposed over a single lens structure disposed proximate to an image sensor having a single partition in accordance with the teachings of the present invention.

FIG. 5 is a block diagram illustrating an example image sensing system in accordance with the teachings of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Example methods and apparatuses directed to a low profile image capture unit are disclosed. As will be appreciated, a low profile image capture unit according to the teachings of the present invention may include a movable color filter grouping having a plurality of colors disposed over a single lens structure on a single image sensor. Furthermore, the quality of optical images captured, which may for example be express in terms of resolution (i.e., the number of pixels) and/or sharpness, is not sacrificed for the low profile in accordance with the teachings of the present invention.

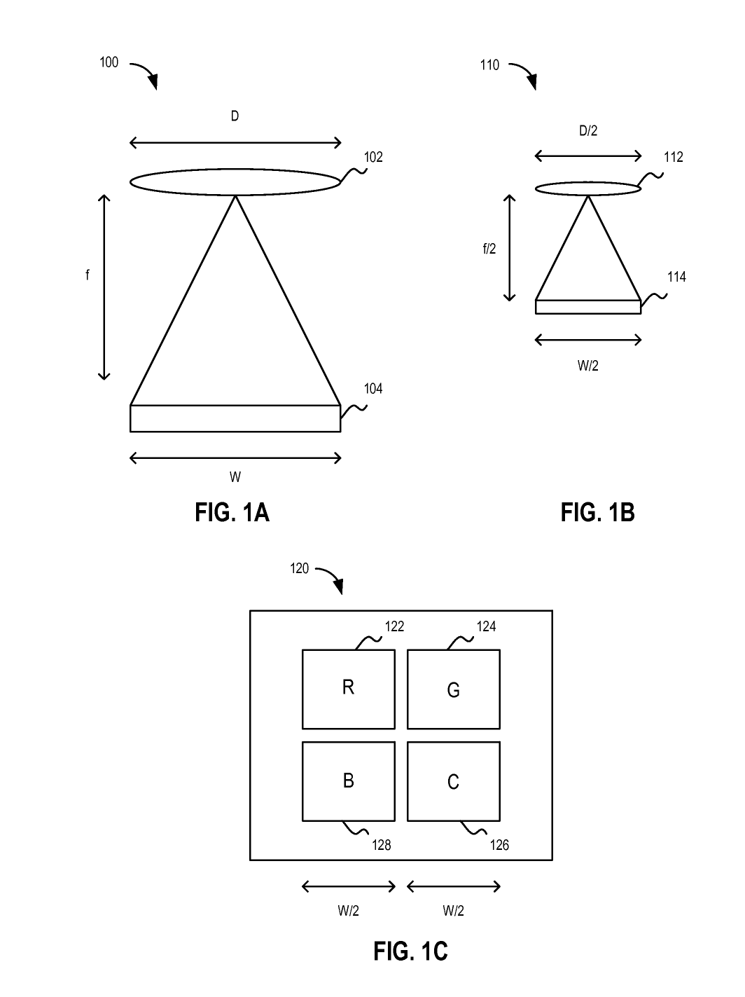

To illustrate, FIG. 1A is a schematic diagram of an image capture unit 100 including an imaging lens 102 and an image sensor 104. The distance between lens 102 and image sensor 104 is approximately f, where f is the focal length of lens 102. The width of the image sensor 104 covered by lens 102 is W, and the lens diameter is D. For comparison, FIG. 1B shows a schematic diagram of a low profile image capture unit 110 including an imaging lens 112 and an image sensor 114. The distance between lens 112 and image sensor 114 is approximately f/2, where f/2 is the focal length of lens 112. The width of the image sensor 114 covered by lens 112 is W/2, and the lens diameter is D/2.

In the low profile image capture unit 110 depicted in FIG. 1B, the imaging lens 102 is replaced with a low profile imaging lens 112, while the size of the image sensor is unchanged. In the example, image sensors 104 and 114 are the same image sensor, and both image sensors have the same pixel array structure. Since the width of image sensor 114 is half of the width of image sensor 104, image sensor 114 will have half of number of pixels as compared with image sensor 104 in one dimension. In two dimensions, image sensor 114 will have quarter of number of pixels as compared with image sensor 104. In other words, the number of pixels of the image captured is approximately proportional to the square of the scale of the distance between the lens and the image sensor.

FIG. 1C illustrates an image sensor 120 having four partitioned areas 122, 124, 126, and 128 closely arranged proximate to each other. Each partitioned area 122,1224, 126, and 128 is covered by a respective imaging lens (e.g., lens 112 of FIG. 1B). In this manner, the focal length of the imaging lens (e.g., lens 112 of FIG. 1B) can be half of the imaging lens when the image sensor is not partitioned into four areas (e.g., lens 102 of FIG. 1A). Thus, a low profile image capture unit can be constructed using four lenses and four partitioned areas of an image sensor. The low profile image capture unit 110 will have approximately the same resolution (i.e., the same number of pixels) as compared with the original image capture unit 100, because four partitioned areas 122,1224, 126, and 128 of the image sensor are used. However, in the example depicted in FIG. 1C, image sensor 120 includes four imaging lenses (e.g., lens 112 of FIG. 1B), with one imaging lens for each of the four partitioned areas 122, 124, 126, and 128. Consequently, as the number of partitions increases in the image sensor, the number of imaging lenses also increases.

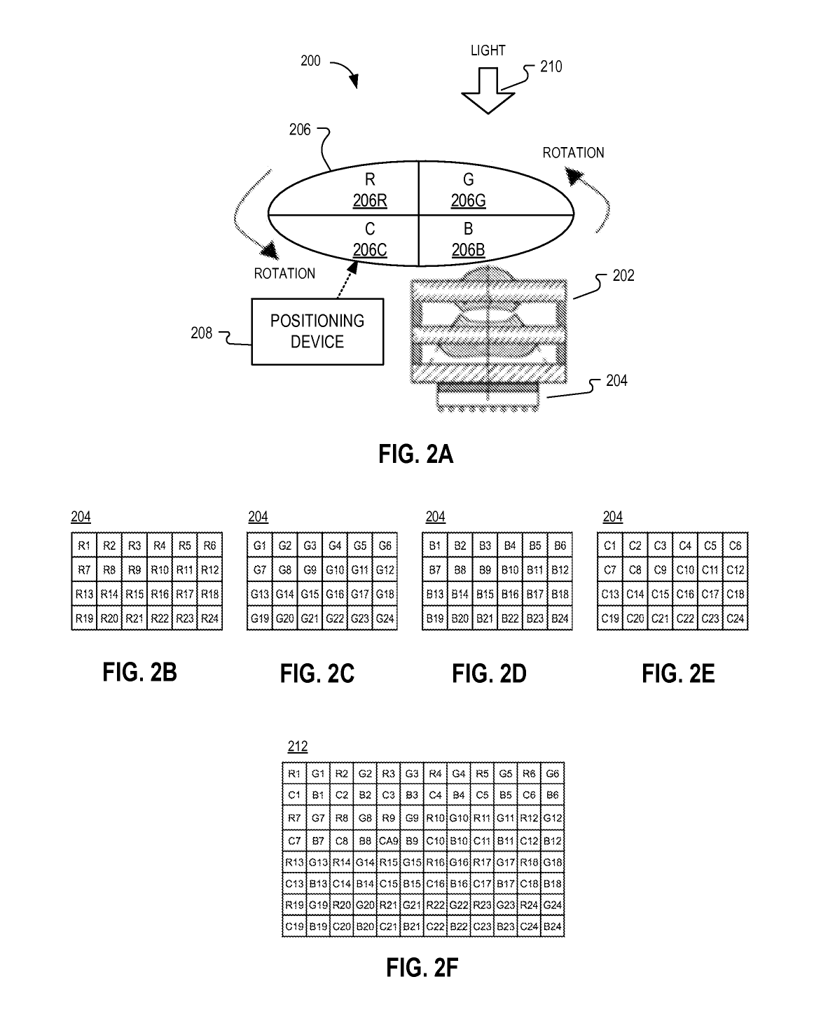

FIG. 2A shows one example of a low profile image capture unit that includes movable color filter grouping disposed over a single lens structure disposed proximate to an image sensor having a single partition in accordance with the teachings of the present invention. In the depicted example, it is appreciated that the example image capture unit illustrated in FIG. 2A realizes the same low profile and the same resolution (i.e., the same number of pixels) as compared with the original image capture unit described above in FIG. 1A, but with only a single lens structure and image sensor partition in accordance with the teachings of the present invention.

In particular, the example illustrated in FIG. 2A shows a low profile image capture unit 200 including an image sensor 204 with a lens structure 202 disposed proximate to the image sensor 204 to focus an image onto the image sensor 204. In the example, image sensor 204 is a single partition that includes a pixel array having a plurality of pixel cells arranged therein. As shown, a movable color filter grouping 206 is disposed over the lens structure 202. The movable color filter grouping 206 includes a plurality of N color filters arranged therein. In the example depicted in FIG. 2A, N=4 and the four color filters arranged in movable color filter grouping 206 include a red color filter 206R, a green color filter 206G, a blue color filter 206B, and a clear color filter 206C. It is appreciated of course that the red, green, blue, and clear color filters are provided in the illustrated example for explanation purposes only, and that other different combinations of color filters may also be provided in accordance with the teachings of the present invention.

The example depicted in FIG. 2A shows that low profile image capture unit 200 also includes a positioning device 208, which is attached to the movable color filter grouping 206 to reposition the movable color filter grouping 206 between each exposure of the image sensor 204. In one example, and as depicted in FIG. 2A, movable color filter grouping 206 may include an RGBC color wheel and positioning device 208 includes a motor attached to the movable color filter grouping 206 to rotate the movable color filter grouping 206 with respect to the lens structure 202 and the image sensor 204 between each successive exposure of image sensor 204. As such, substantially all of the light 210 that is incident upon the image sensor 204 through the lens structure 202 is directed through a different one of the plurality of N color filters 206R, 206G, 206B, or 206C for each successive exposure of the image sensor 204 in accordance with the teachings of the present invention. In one example, N successive exposures of the image sensor 204 are coupled to be combined into a single color image in accordance with the teachings of the present invention.

To illustrate, FIG. 2B shows an example of pixel cell image data values in the pixel array of image sensor 204 after an exposure of image sensor 204 with all of the incident light 210 directed through red color filter 206R of movable color filter grouping 206 and lens structure 202 in accordance with the teachings of the present invention. As shown, all of the pixel cell image data values represent red image data values R1, R2, . . . , R24. It is appreciated of course that although image sensor 204 is illustrated as including only 24 image data values R1, R2, . . . , R24 in FIG. 2B for explanation purposes, the pixel array of image sensor 204 may include a different number of pixel cells in accordance with the teachings of the present invention.

Continuing with the example described in FIG. 2B, after the exposure of image sensor 204 with substantially all of the light 210 directed through red color filter 206R as shown, positioning device 208 may than re-position movable color filter grouping 206 such that for the next successive exposure, substantially all of the light 210 that is incident on image sensor 204 is directed through green color filter 206G of movable color filter grouping 206 in accordance with the teachings of the present invention.

Accordingly, FIG. 2C shows an example of pixel cell image data values in the pixel array of image sensor 204 after an exposure of image sensor 204 with all of the incident light 210 directed through green color filter 206G of movable color filter grouping 206 and lens structure 202 in accordance with the teachings of the present invention. As shown, all of the pixel cell image data values represent green image data values G1, G2, . . . , G24.

Continuing with the example described in FIG. 2C, after the exposure of image sensor 204 with substantially all of the light 210 directed through green color filter 206G as shown, positioning device 208 may than re-position movable color filter grouping 206 such that for the next successive exposure, substantially all of the light 210 that is incident on image sensor 204 is directed through blue color filter 206B of movable color filter grouping 206 in accordance with the teachings of the present invention.

Accordingly, FIG. 2D shows an example of pixel cell image data values in the pixel array of image sensor 204 after an exposure of image sensor 204 with all of the incident light 210 directed through blue color filter 206B of movable color filter grouping 206 and lens structure 202 in accordance with the teachings of the present invention. As shown, all of the pixel cell image data values represent blue image data values B1, B2, . . . , B24.

Continuing with the example described in FIG. 2D, after the exposure of image sensor 204 with substantially all of the light 210 directed through blue color filter 206B as shown, positioning device 208 may than re-position movable color filter grouping 206 such that for the next successive exposure, substantially all of the light 210 that is incident on image sensor 204 is directed through clear color filter 206C of movable color filter grouping 206 in accordance with the teachings of the present invention.

Accordingly, FIG. 2E shows an example of pixel cell image data values in the pixel array of image sensor 204 after an exposure of image sensor 204 with all of the incident light 210 directed through clear color filter 206C of movable color filter grouping 206 and lens structure 202 in accordance with the teachings of the present invention. As shown, all of the pixel cell image data values represent clear image data values C1, C2, . . . , C24.

FIG. 2F illustrates that in one example, after the N successive exposures of image sensor 204 through each of the different N color filters of movable color filter grouping 206, the image data from the N successive exposures of the image sensor 204, such as for example as illustrated above in FIGS. 2B-2E, are coupled to be combined into a single color image 212 in accordance with the teachings of the present invention. In particular, in the example depicted in FIG. 2E, the red, green, blue, and clear image channels are combined 4 to 1 into single color image 212 by re-arranging the order as shown in accordance with the teachings of the present invention.

Accordingly, a high resolution color image 212 may be realized using low profile image capture unit 200 using only a single lens structure 202 and image sensor 204 partition with movable color filter grouping 206 in accordance with the teachings of the present invention. As such, low profile image capture unit 200 only needs a single lens structure instead of an array of lens structures, compared to for example image sensor 120, as described above in FIG. 1C. Since only one lens structure 202 is needed, overall lens performance may be improved, and overall volume and cost and cost savings may be realized, since only one lens structure is needed instead of an array of lens structures for each image capture unit in accordance with the teachings of the present invention.

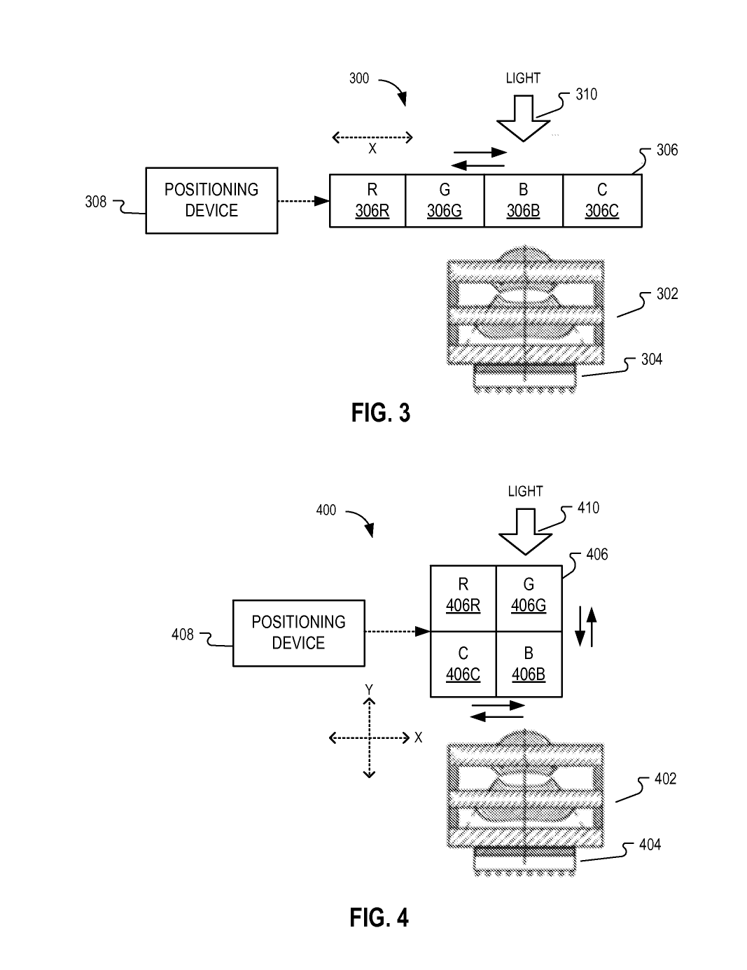

FIG. 3 shows another example of a low profile image capture unit 300 that includes movable color filter grouping disposed over a single lens structure disposed proximate to an image sensor having a single partition in accordance with the teachings of the present invention. In the depicted example, it is appreciated that the example image capture unit illustrated in FIG. 3 also realizes the same low profile and the same resolution (i.e., the same number of pixels) as compared with the original image capture unit described above in FIG. 1A, but with only a single lens structure and image sensor partition in accordance with the teachings of the present invention.

In particular, the example low profile image capture unit 300 depicted in FIG. 3 includes an image sensor 304 with a lens structure 302 disposed proximate to the image sensor 304 to focus an image onto the image sensor 304. In the example, image sensor 304 is a single partition that includes a pixel array having a plurality of pixel cells arranged therein. As shown, a movable color filter grouping 306 is disposed over the lens structure 302. The movable color filter grouping 306 includes a plurality of N color filters arranged therein. In the example depicted in FIG. 3, N=4 and the four color filters arranged in movable color filter grouping 306 include a red color filter 306R, a green color filter 306G, a blue color filter 306B, and a clear color filter 306C.

The example depicted in FIG. 3 shows that low profile image capture unit 300 also includes a positioning device 308, which is attached to the movable color filter grouping 306 to reposition the movable color filter grouping 306 between each exposure of the image sensor 304. In one example, and as depicted in FIG. 3, movable color filter grouping 306 may include an RGBC color guide, which in the illustrated example includes red color filter 306R, a green color filter 306G, a blue color filter 306B, and a clear color filter 306C arranged along one direction, such as for example along the x-axis, as shown.

In one example, positioning device 308 includes an actuator attached to the movable color filter grouping 306 to shift the movable color filter grouping 306, such as for example along the x-axis, with respect to the lens structure 302 and the image sensor 304 between each successive exposure of image sensor 304. For instance, in one example the actuator of positioning device 308 includes a voice coil module actuator attached to the movable color filter grouping 306. In another example, the actuator includes a piezo actuator attached to the movable color filter grouping 306. In still another example, the actuator includes a micro-electro-mechanical system (MEMS) actuator attached to the movable color filter grouping 306. In various examples, a frequency of the actuator of positioning device 308 is greater than a frame rate of the image sensor 304. In various examples, a moving speed of the actuator of positioning device 308 is greater than a shutter speed of the image sensor 304.

Continuing with the example depicted in FIG. 3, substantially all of the light 310 that is incident upon the image sensor 304 through the lens structure 302 is directed through a different one of the plurality of N color filters 306R, 306G, 306B, or 306C for each successive exposure of the image sensor 304 in accordance with the teachings of the present invention. In one example, N successive exposures of the image sensor 304 are coupled to be combined into a single color image, in a similar fashion as described in the example above in FIGS. 2B-2E in accordance with the teachings of the present invention. In one example, the positioning device 308 cycles through all of the plurality of N color filters of movable color filter grouping 306 after the N successive exposures of image sensor 304 in accordance with the teachings of the present invention.

FIG. 4 shows yet another example of a low profile image capture unit 400 that includes movable color filter grouping disposed over a single lens structure disposed proximate to an image sensor having a single partition in accordance with the teachings of the present invention. In the depicted example, it is appreciated that the example image capture unit illustrated in FIG. 4 also realizes the same low profile and the same resolution (i.e., the same number of pixels) as compared with the original image capture unit described above in FIG. 1A, but with only a single lens structure and image sensor partition in accordance with the teachings of the present invention.

In particular, the example low profile image capture unit 400 illustrated in FIG. 4 includes an image sensor 404 with a lens structure 402 disposed proximate to the image sensor 404 to focus an image onto the image sensor 404. In the example, image sensor 404 is a single partition that includes a pixel array having a plurality of pixel cells arranged therein. As shown, a movable color filter grouping 406 is disposed over the lens structure 402. The movable color filter grouping 406 includes a plurality of N color filters arranged therein. In the example depicted in FIG. 4, N=4 and the four color filters arranged in movable color filter grouping 406 include a red color filter 406R, a green color filter 406G, a blue color filter 406B, and a clear color filter 406C.

The example depicted in FIG. 4 shows that low profile image capture unit 400 also includes a positioning device 408, which is attached to the movable color filter grouping 406 to reposition the movable color filter grouping 406 between each exposure of the image sensor 3404. In one example, and as depicted in FIG. 4, movable color filter grouping 406 may include an RGBC color square, which in the illustrated example includes red color filter 406R, a green color filter 406G, a blue color filter 406B, and a clear color filter 406C arranged along two directions, such as for example along the x-axis, and along the y-axis as shown.

In one example, positioning device 408 includes an actuator attached to the movable color filter grouping 306 to shift the movable color filter grouping 406, such as for example along the x-axis, or along the y-axis, with respect to the lens structure 402 and the image sensor 404 between each successive exposure of image sensor 404. For instance, in one example the actuator of positioning device 408 includes a voice coil module actuator attached to the movable color filter grouping 406. In another example, the actuator includes a piezo actuator attached to the movable color filter grouping 406. In still another example, the actuator includes a micro-electro-mechanical system (MEMS) actuator attached to the movable color filter grouping 306. In various examples, a frequency of the actuator of positioning device 408 is greater than a frame rate of the image sensor 404. In various examples, a moving speed of the actuator of positioning device 308 is greater than a shutter speed of the image sensor 404.

Continuing with the example depicted in FIG. 4, substantially all of the light 410 that is incident upon the image sensor 404 through the lens structure 402 is directed through a different one of the plurality of N color filters 406R, 406G, 406B, or 406C for each successive exposure of the image sensor 404 in accordance with the teachings of the present invention. In one example, N successive exposures of the image sensor 404 are coupled to be combined into a single color image, in a similar fashion as described in the example above in FIGS. 2B-2E in accordance with the teachings of the present invention. In one example, the positioning device 408 cycles through all of the plurality of N color filters of movable color filter grouping 406 after N successive exposures of image sensor 404 in accordance with the teachings of the present invention.

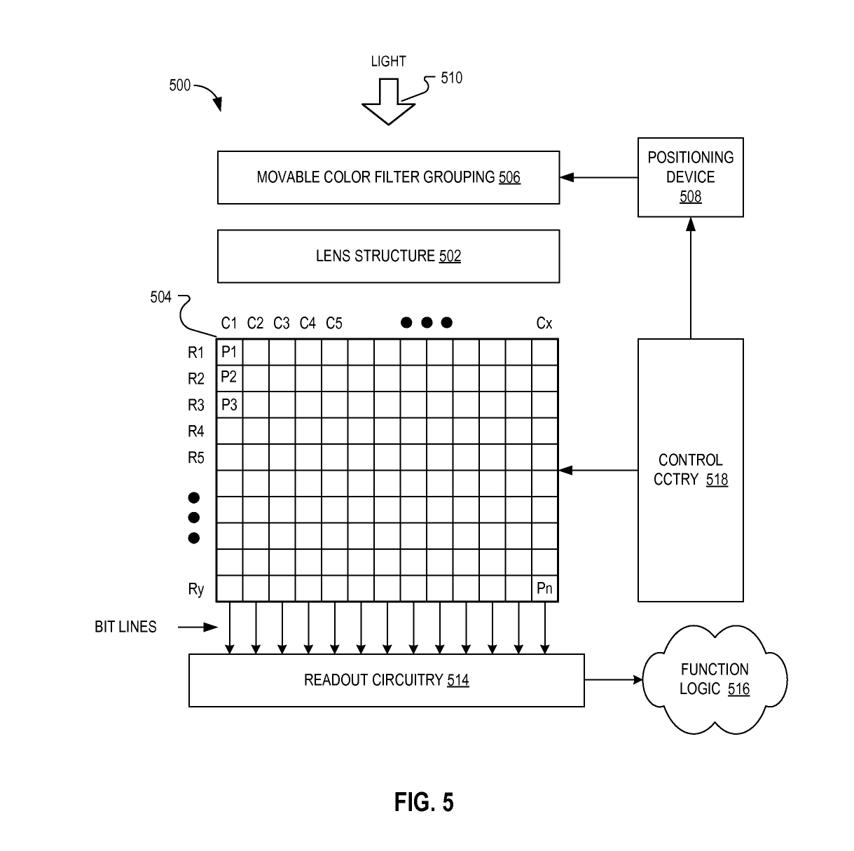

FIG. 5 is a block diagram illustrating an example image sensing system 500 in accordance with the teachings of the present invention. In one example, image sensing system 500 may be an example of low profile image capture unit 200 of FIG. 2A, or of low profile image capture unit 300 of FIG. 3, or of low profile image capture unit 400 of FIG. 4 in accordance with the teachings of the present invention. Accordingly, it is noted that that similarly named and numbered elements referenced below are coupled and function similar to as described above. In the example depicted in FIG. 5, image sensing system 500 includes an image sensor 504, readout circuitry 514, function logic 516, and control circuitry 518. In one example, image sensing system 500 further includes a lens structure 502 disposed proximate to the image sensor 504 to focus an image onto the image sensor 504, a movable color filter grouping 506 disposed over the lens structure 502, and a positioning device 508 attached to the movable color filter grouping 506 to reposition a plurality of N color filters included in movable color filter grouping 506 between each exposure of the image sensor 504. In one example, substantially all of the light 510 that is incident upon the image sensor 504 through the lens structure 502 is directed through a different one of the plurality of N color filters of movable color filter grouping 506 for each successive exposure of the image sensor 504 in accordance with the teachings of the present invention. In one example, N successive exposures of the image sensor 504 are coupled to be combined into a single color image in accordance with the teachings of the present invention. In one example, control circuitry 518 is coupled to the image sensor 504 to control operation of the image sensor 504. In one example, control circuitry 518 is further coupled to the positioning device 508 to control the repositioning of the N plurality of color filters of movable color filter grouping 506 as discussed above in accordance with the teachings of the present invention.

In one example, as shown in the example depicted in FIG. 5, image sensor 504 includes a two-dimensional (2D) pixel array having a plurality of pixel cells (e.g., P1, P2, . . . Pn) arranged therein. Each pixel cell may be a CMOS pixel or a CCD pixel. As illustrated, each pixel cell is arranged into a row (e.g., rows R1 to Ry) and a column (e.g., column C1 to Cx) to acquire image data of a person, place, object, etc., which can then be used to render a 2D image of the person, place, object, etc. In one example, image sensor 504 is a backside illuminated (BSI) image sensor. In one example, image sensor 504 is a frontside illuminated (FSI) image example. In the depicted example image sensor 504 is a single partition and is covered by lens structure 502 and movable color filter grouping 506 as discussed above in accordance with the teachings of the present invention

After each successive exposure of image sensor 504 after which each pixel cell has acquired its image data or image charge, the image data is readout by readout circuitry 514 and transferred to function logic 516. Readout circuitry 514 may include amplification circuitry, analog-to-digital (ADC) conversion circuitry, or otherwise. Function logic 516 may simply store the image data or even manipulate the image data by applying post image effects (e.g., crop, rotate, remove red eye, adjust brightness, adjust contrast, or otherwise). In one example, the function logic 516 is coupled to the readout circuitry 514 to combine the N successive exposures of the image sensor 504 into a single color image, as discussed above in accordance with the teachings of the present invention. In one example, readout circuitry 514 may readout a row of image data at a time along readout column lines (illustrated) or may readout the image data using a variety of other techniques (not illustrated), such as a serial readout or a full parallel readout of all pixels simultaneously.

Control circuitry 518 is coupled to image sensor 504 to control operational characteristic of image sensor 504. For example, control circuitry 518 may generate a shutter signal for controlling image acquisition. In one example, the shutter signal is a global shutter signal for simultaneously enabling all pixels within image sensor 504 to simultaneously capture their respective image data during a single acquisition window. In another example, the shutter signal is a rolling shutter signal whereby each row, column, or group of pixels is sequentially enabled during consecutive acquisition windows.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. An image capture unit, comprising:
an image sensor including a pixel array having a plurality of pixel cells arranged therein;
a lens structure disposed proximate to the image sensor to focus an image onto the image sensor;
a movable color filter grouping disposed over the lens structure, wherein the movable color filter grouping includes a plurality of N color filters arranged therein such that all light that is incident upon the image sensor through the lens structure is directed through only one of the plurality of N color filters of the movable color filter grouping per each exposure of the image sensor; and
a positioning device attached to the movable color filter grouping to reposition the movable color filter grouping between each exposure of the image sensor such that substantially all of the light that is incident upon the image sensor through the lens structure is directed through a different one of the plurality of N color filters for each successive exposure of the image sensor.

2. The image capture unit of claim 1 wherein the plurality of N color filters includes a red filter, a green filter, a blue filter, and a clear filter.

3. The image capture unit of claim 1 wherein N successive exposures of the image sensor are coupled to be combined into a single color image.

4. The image capture unit of claim 1 wherein the plurality of N color filters includes a red filter, a green filter, a blue filter, and a clear filter.

5. The image capture unit of claim 1 wherein the positioning device includes a motor attached to the movable color filter grouping to rotate the movable color filter grouping with respect to the lens structure and the image sensor.

6. The image capture unit of claim 1 wherein the positioning device includes an actuator attached to the movable color filter grouping to shift the movable color filter grouping along an x direction with respect to the lens structure and the image sensor.

7. The image capture unit of claim 6 wherein the actuator is attached to the movable color filter grouping is further coupled to shift the movable color filter grouping along a y direction with respect to the lens structure and the image sensor.

8. The image capture unit of claim 6 wherein the actuator comprises a voice coil module actuator attached to the movable color filter grouping.

9. The image capture unit of claim 6 wherein the actuator comprises a piezo actuator attached to the movable color filter grouping.

10. The image capture unit of claim 6 wherein the actuator comprises a micro-electro-mechanical system (MEMS) actuator attached to the movable color filter grouping.

11. The image capture unit of claim 6 wherein a frequency of the actuator attached to the movable color filter grouping is greater than a frame rate of the image capture unit the image sensor.

12. The image capture unit of claim 6 wherein a moving speed of the actuator attached to the movable color filter grouping is greater than a shutter speed of the image sensor.

13. An imaging system, comprising:
an image sensor including a pixel array having a plurality of pixel cells arranged therein;
a lens structure disposed proximate to the image sensor to focus an image onto the image sensor;
a movable color filter grouping disposed over the lens structure, wherein the movable color filter grouping includes a plurality of N color filters arranged therein such that all light that is incident upon the image sensor through the lens structure is directed through only one of the plurality of N color filters of the movable color filter grouping per each exposure of the image sensor;
a positioning device attached to the movable color filter grouping to reposition the movable color filter grouping between each exposure of the image sensor such that substantially all of the light that is incident upon the image sensor through the lens structure is directed through a different one of the plurality of N color filters for each successive exposure of the image sensor; and
control circuitry coupled to the pixel array to control operation of the pixel array, the control circuitry further coupled to the positioning device to control the repositioning of the movable color filter grouping; and
readout circuitry coupled to the image sensor to readout image data from the plurality of pixels.

14. The imaging system of claim 13 further comprising function logic coupled to the readout circuitry to store the image data readout from the image sensor region.

15. The imaging system of claim 14 wherein the function logic is coupled to the readout circuitry to combine N successive exposures of the image sensor into a single color image.

16. The imaging system of claim 13 wherein the plurality of N color filters includes a red filter, a green filter, a blue filter, and a clear filter.

17. The imaging system of claim 13 wherein the positioning device includes a motor attached to the movable color filter grouping to rotate the movable color filter grouping with respect to the lens structure and the image sensor.

18. The imaging system of claim 13 wherein the positioning device includes an actuator attached to the movable color filter grouping to shift the movable color filter grouping along an x direction with respect to the lens structure and the image sensor.

19. The imaging system of claim 18 wherein the actuator is attached to the movable color filter grouping is further coupled to shift the movable color filter grouping along a y direction with respect to the lens structure and the image sensor.

20. The imaging system of claim 18 wherein the actuator comprises a voice coil module actuator attached to the movable color filter grouping.

21. The imaging system of claim 18 wherein the actuator comprises a piezo actuator attached to the movable color filter grouping.

22. The imaging system of claim 18 wherein the actuator comprises a micro-electro-mechanical system (MEMS) actuator attached to the movable color filter grouping.
